(19) United States
(12) Patent Application Publication
(10) Pub. No.: US 2026/0252959 A1
(43) Pub. Date: Aug. 27, 2026

(54) PRIVACY PROTECTION IN VERTICAL FEDERATED LEARNING

(71) Applicant: Nokia Solutions and Networks Oy, Espoo (FI)

(72) Inventor: Borzoo Rassouli, Stuttgart (DE)

(21) Appl. No.: 19/533,519

(22) Filed: Feb. 9, 2026

(30) Foreign Application Priority Data
Feb. 21, 2025 (FI) 20255156

(51) Int. Cl. G06N 20/00

(52) U.S. Cl. CPC G06N 20/00

(57) ABSTRACT

Measures for privacy protection that comprise, at a machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, at least one feature of said plurality of features of said data sample being assigned to said machine learning model implementation entity, calculating, for each of said at least one feature, a modified feature, and determining a machine learning model prediction result for said data sample.

### FIELD

Various example embodiments relate to privacy protection in vertical federated learning. More specifically, various example embodiments exemplarily relate to measures (including methods, apparatuses and computer program products) for realizing privacy protection in vertical federated learning.

### BACKGROUND

The present specification generally relates to impeding reconstruction of features of data samples in a prediction phase of a global machine learning model in vertical federated learning (VFL) scenarios.

Machine learning (ML) is a field in artificial intelligence (AI) concerned with the development of statistical algorithms that can learn from data and generalize to unseen data, and thus perform tasks without explicit instructions. ML finds application in many fields, including natural language processing, computer vision, speech recognition, email filtering, agriculture, medicine, and predictive analytics.

Distributed artificial intelligence (DAI) is a subfield of artificial intelligence research dedicated to the development of distributed solutions for problems.

Federated learning (FL) is an adapted form of distributed artificial intelligence to training machine learning models that decentralizes the training process, allowing privacy to be maintained by not needing to send data to a centralized server. This also increases efficiency by decentralizing the training process to many devices. In detail, to tackle the various concerns in the traditional centralized learning framework, i.e., privacy, storage, and computational complexity, FL has been proposed, where an ML model is jointly trained by multiple local data owners (i.e., parties), such as smart phones, data centers, etc., without revealing their private data to each other.

FL has three main variants based on how data is partitioned among participating parties: horizontal federated learning (HFL), vertical federated learning (VFL), and federated transfer learning.

In VFL, parties share common data samples with disjoint sets of features.

In a VFL scenario, there may be an active party (a corresponding (network) entity) and at least one passive party (at least one corresponding (network) entity). The active party may for example wish to build a binary classification model to make a certain decision by utilizing features (of the shared data samples) from the passive party. In this context, only the active party may have access to class labels in the training and testing datasets, hence named the active party, while passive party may be unaware of the labels.

Once the model is trained, which may involve (typically involves) a coordinator entity, in a prediction phase, the model can be used to predict the decision to be made in the prediction dataset. The model outputs, referred to as the prediction outputs, are revealed to the active party that is in charge of making the decision.

Upon receiving the prediction outputs, which often depend on the passive party's features, the active party can perform reconstruction attack to estimate the passive party's features, thereby acting as an adversary in this context.

Hence, the problem arises that the passive party's features of the common data samples with disjoint sets of features which are to be kept private (which are regarded as sensitive information) may be exposed using reconstructions attacks.

Hence, there is a need to provide for privacy protection in vertical federated learning.

### SUMMARY

Various example embodiments aim at addressing at least part of the above issues and/or problems and drawbacks.

Various aspects of example embodiments are set out in the appended claims.

According to an exemplary aspect, there is provided a method of a machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, at least one feature of said plurality of features of said data sample being assigned to said machine learning model implementation entity, the method comprising calculating, for each of said at least one feature, a modified feature, and determining a machine learning model prediction result for said data sample utilizing said local machine learning model and said at least one modified feature.

According to an exemplary aspect, there is provided an apparatus of a machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, at least one feature of said plurality of features of said data sample being assigned to said machine learning model implementation entity, the apparatus comprising at least one processor, and at least one memory storing instructions that, when executed by the at least one processor, cause the apparatus at least to perform calculating, for each of said at least one feature, a modified feature, and determining a machine learning model prediction result for said data sample utilizing said local machine learning model and said at least one modified feature.

According to an exemplary aspect, there is provided an apparatus of a machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, at least one feature of said plurality of features of said data sample being assigned to said machine learning model implementation entity, the apparatus comprising calculating circuitry configured to calculate, for each of said at least one feature, a modified feature, and determining circuitry configured to determine a machine learning model prediction result for said data sample utilizing said local machine learning model and said at least one modified feature.

According to an exemplary aspect, there is provided an apparatus comprising means for carrying out the method according to any one of the aforementioned method-related exemplary aspects of the present disclosure.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

According to an exemplary aspect, there is provided a non-transitory computer readable medium comprising instructions, which, when executed by an apparatus, cause the apparatus to perform the method according to any one of the aforementioned method-related exemplary aspects of the present disclosure.

Any one of the above aspects enables an efficient concealment of the passive party's features of the common data samples with disjoint sets of features which are to be kept private (which are regarded as sensitive information) to thereby solve at least part of the problems and drawbacks identified in relation to the prior art.

By way of example embodiments, there is provided privacy protection in vertical federated learning. More specifically, by way of example embodiments, there are provided measures and mechanisms for realizing privacy protection in vertical federated learning.

Thus, improvement is achieved by methods, apparatuses and computer program products enabling/realizing privacy protection in vertical federated learning.

### BRIEF DESCRIPTION OF THE DRAWINGS

In the following, the present disclosure will be described in greater detail by way of non-limiting examples with reference to the accompanying drawings, in which

FIG. 1 is a block diagram illustrating an apparatus according to example embodiments,

FIG. 2 is a block diagram illustrating an apparatus according to example embodiments,

FIG. 3 is a schematic diagram of a procedure according to example embodiments,

FIG. 4 shows a schematic diagram of an example of a VFL scenario, illustrating data samples disjoint among the participants of the VFL,

FIG. 5 shows a schematic diagram illustrating an exemplary reconstruction attack regarding a feature of a data sample,

FIG. 6 shows a schematic diagram of an example of a system environment schematically illustrating a procedure according to example embodiments,

FIG. 7 shows diagrams comparing privacy preserving schemes according to example embodiments,

FIG. 8 shows diagrams comparing privacy preserving schemes according to example embodiments,

FIG. 9 shows diagrams comparing privacy preserving schemes according to example embodiments, and

FIG. 10 is a block diagram alternatively illustrating an apparatus according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain machine learning model implementation configurations and deployments. As such, the description of example embodiments given herein specifically refers to terminology which is directly related thereto. Such terminology is only used in the context of the presented non-limiting examples, and does naturally not limit the disclosure in any way. Any configuration and deployment etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

According to example embodiments, in general terms, there are provided measures and mechanisms for (enabling/realizing) privacy protection in vertical federated learning.

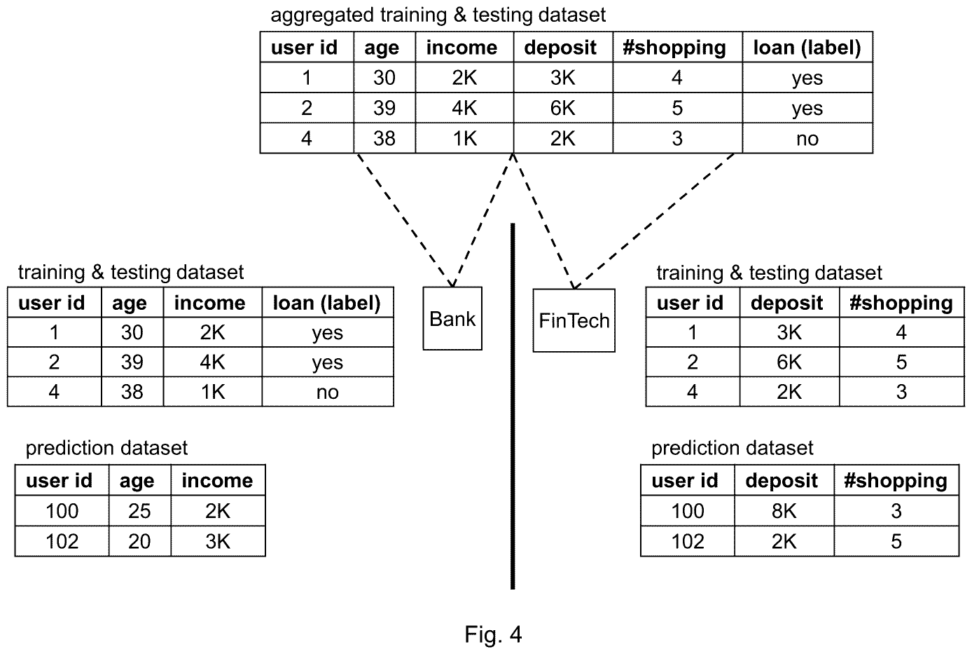

FIG. 4 shows a schematic diagram of an example of a VFL scenario, illustrating data samples disjoint among the participants of the VFL, and in particular illustrates digital banking as an example scenario of VFL.

In the example in FIG. 4, a digital banking system is shown as an example of an VFL setting, in which two parties are participating, namely, a bank and a Financial Technology (FinTech) company.

It is explicitly highlighted that this example scenario is for general explanation only and is not intended to limit the application field of the present disclosure in any way. Rather, the principles of the present disclosure are applicable to any technical field allowing the implementation of machine learning and machine learning models.

In the illustrated example, the bank may wish to build a binary classification model to approve/disapprove a user's credit card application by utilizing more features from the FinTech company. In this context, only the bank may have access to the class labels in the training and testing datasets, hence named the active party, while the FinTech company, which may be unaware of the labels, is referred to as the passive party.

In a prediction phase, once the model is trained, which may involve and typically involves a coordinator, the model can be used to predict the decision (approve/disapprove) on a new credit card application in the prediction dataset.

The model outputs, referred to as the prediction outputs or more specifically, the confidence scores, are revealed to the active party that is in charge of making the decision.

Upon receiving the prediction outputs, which often depend on the passive party's features, the active party can perform reconstruction attack to estimate the passive party's features, thereby acting as the adversary in this context.

Namely, considering a two-party VFL, with one active and one passive party with k-class logistic regression as the trained model, in the prediction phase:
the passive party computes WₚₐₛX, and sends it to the coordinator (Wₚₐₛ is the k by d dimensional matrix as the model parameters of the passive party, and X denotes the d dimensional features it holds),
the active party computes W_{act}Y, and sends it to the coordinator (W_{act} is the k by n dimensional matrix as the model parameters of the active party, and Y denotes the d dimensional features it holds), and
the coordinator computes the k dimensional confidence scores c=σ(WₚₐₛX+W_{act}Y) and reveals it to the active party for classification, where σ(·) denotes the softmax function.

The confidence scores rely on the passive party's features X. Hence, the adversary (i.e., the active party in the present case) is able to perform a reconstruction attack to estimate the passive party's features.

A possible approach for facilitating privacy with respect to the passive party's features X includes the coordinator adding noise to the confidence scores and revealing only a noisy version of the confidence scores to the active party.

Such possible approach suffers from the following drawbacks.

According to this possible approach, the task of protecting the privacy of the features in passive party is delegated to the coordinator.

This, in turn, comes with the following three practical issues:
1. The privacy guarantee would then hinge on the passive party's trust in the coordinator, which can be easily violated.
2. The coordinator, originally defined as a neutral entity trusted by both parties, would then be working in favor of one party and against the other, which contradicts the initial assumption.
3. The existence of a coordinator is not mandatory for VFL, meaning this possible approach would fail in the absence of a coordinator.

In addition, there is no analytical investigation of the corresponding utility-privacy trade-off with respect to such possible approach, where utility denotes the model accuracy, and the privacy is captured by the mean squared error per feature of the reconstruction attack, i.e.,

$$M S E = \frac{1}{d} E [ {‖ X - \hat{X} ‖}^{2} ] ,$$

where \hat{X} denotes the adversary's estimate in the reconstruction attack. In this context, the more the MSE, the more private the VFL is in the prediction phase.

Hence, in brief, according to example embodiments, privacy-preserving schemes against feature reconstruction attacks in the prediction phase of VFL are provided.

Namely, according to example embodiments, the passive party (i.e. a machine learning model implementation entity implementing the passive party) takes care of protecting the privacy of its features. Advantageously, according to example embodiments, drawbacks (1., 2., 3.) outlined above with reference to a possible approach for facilitating privacy with respect to the passive party's features X including the coordinator adding noise to the confidence scores and revealing only a noisy version of the confidence scores to the active party can be circumvented.

To this end, according to example embodiments, the machine learning model implementation entity implementing the passive party adds noise to its features in a specific direction in the Euclidean R^{d} space. Advantageously, by restricting the noise power in a specific direction in the feature space, maximal degradation of the adversary's reconstruction attack occurs for a given drop in utility.

Example embodiments are specified below in more detail.

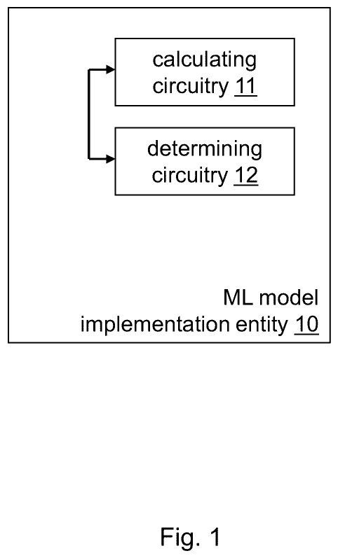

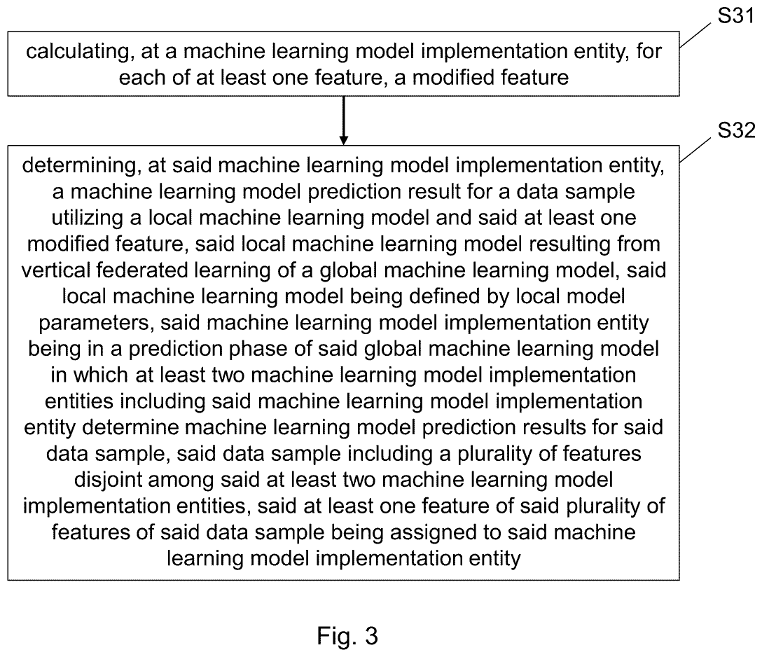

FIG. 1 is a block diagram illustrating an apparatus according to example embodiments. The apparatus may be a machine learning model implementation entity (or any network device or entity implementing such machine learning model implementation entity) 10, such as a passive party in a prediction phase of vertical federated learning (the machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, at least one feature of said plurality of features of said data sample being assigned to said machine learning model implementation entity), the machine learning model implementation entity (or any network device or entity implementing such machine learning model implementation entity) 10 comprising a calculating circuitry 11 and a determining circuitry 12. The calculating circuitry 11 calculates, for each of said at least one feature, a modified feature. The determining circuitry 12 determines a machine learning model prediction result for said data sample utilizing said local machine learning model and said at least one modified feature. FIG. 3 is a schematic diagram of a procedure according to example embodiments. The apparatus according to FIG. 1 may perform the method of FIG. 3 but is not limited to this method. The method of FIG. 3 may be performed by the apparatus of FIG. 1 but is not limited to being performed by this apparatus.

As shown in FIG. 3, a procedure (of a machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, at least one feature of said plurality of features of said data sample being assigned to said machine learning model implementation entity) according to example embodiments comprises an operation of calculating (S31), for each of said at least one feature, a modified feature, and an operation of determining (S32) a machine learning model prediction result for said data sample utilizing said local machine learning model and said at least one modified feature.

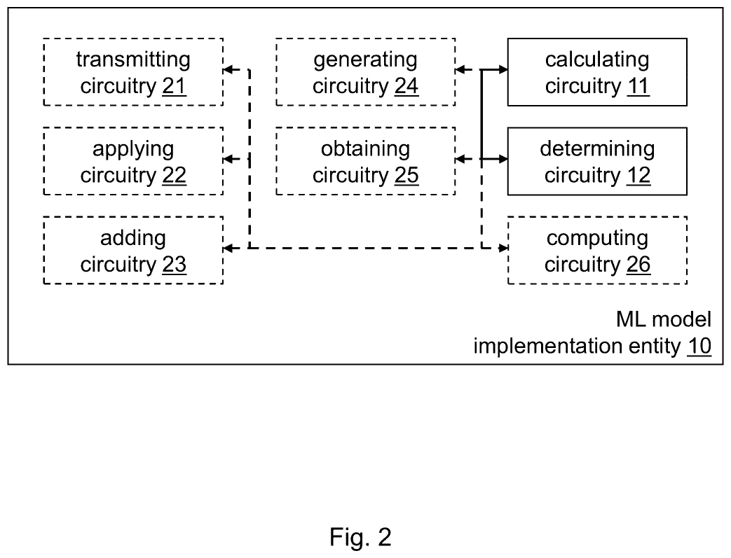

FIG. 2 is a block diagram illustrating an apparatus according to example embodiments. In particular, FIG. 2 illustrates a variation of the apparatus shown in FIG. 1. The apparatus according to FIG. 2 may thus further comprise a transmitting circuitry 21, an applying circuitry 22, an adding circuitry 23, a generating circuitry 24, an obtaining circuitry 25, and/or a computing circuitry 26.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to a variation of the procedure shown in FIG. 3, exemplary additional operations are given, which are inherently independent from each other as such. According to such variation, an exemplary method according to example embodiments may comprise an operation of transmitting said machine learning model prediction result for said data sample.

According to a variation of the procedure shown in FIG. 3, exemplary details of the calculating operation (S31) are given, which are inherently independent from each other as such. Such exemplary calculating operation (S31) according to example embodiments may comprise an operation of applying noise to said each of said at least one feature.

According to a variation of the procedure shown in FIG. 3, exemplary details of the applying operation are given, which are inherently independent from each other as such. Such exemplary applying operation according to example embodiments may comprise an operation of adding said noise to said each of said at least one feature.

According to further example embodiments, said noise is directed noise.

According to a variation of the procedure shown in FIG. 3, exemplary additional operations are given, which are inherently independent from each other as such. According to such variation, an exemplary method according to example embodiments may comprise an operation of generating said noise based on said local model parameters.

According to a variation of the procedure shown in FIG. 3, exemplary additional operations are given, which are inherently independent from each other as such. According to such variation, an exemplary method according to example embodiments may comprise an operation of generating said noise based on said local model parameters and a value indicative of a target model accuracy.

According to a variation of the procedure shown in FIG. 3, exemplary details of the generating operation are given, which are inherently independent from each other as such. Such exemplary generating operation according to example embodiments may comprise an operation of obtaining a direction of said noise based on said local model parameters.

According to further example embodiments, said direction is specified in Euclidean R^{d} space.

According to a variation of the procedure shown in FIG. 3, exemplary additional operations are given, which are inherently independent from each other as such. According to such variation, an exemplary method according to example embodiments may comprise an operation of computing a noise vector representing said noise according to a multivariate Gaussian distribution.

According to further example embodiments, said multivariate Gaussian distribution is represented by [symbol] (0,S*),
where

$${S}^{*} = α ( {V}_{w} {\sum }_{w}^{+} {ν}^{*} ) {( {V}_{w} {\sum }_{w}^{+} {ν}^{*} )}^{T} ,$$

where

$${\sum }_{w}^{+}$$

is a pseudoinverse of Σ_{w},

$${( {V}_{w} {\sum }_{w}^{+} {ν}^{*} )}^{T}$$

is a transpose of

$$( {V}_{w} {\sum }_{w}^{+} {ν}^{*} ) , {U}_{w} {\sum }_{w} {V}_{w}^{T}$$

is a singular value decomposition of said local model parameters,

$${V}_{w}^{T}$$

is a transpose of V_{w}, and v* is a singular vector corresponding to a maximum singular value of

$${A}^{+} A {V}_{w} {\sum }_{w}^{+} ,$$

where A⁺ is a pseudoinverse of A, A is a multiplication of a difference matrix J by said local model parameters, and the difference matrix J is defined as

$$J {=}^{Δ} {[ \begin{matrix}- 1 & 1 & 0 & 0 & … & 0 \\ 0 & - 1 & 1 & 0 & … & 0 \\ 0 & 0 & - 1 & 1 & … & 0 \\ ⋮ & ⋮ & ⋮ & ⋮ & ⋱ & ⋮ \\ 0 & … & … & 0 & - 1 & 1\end{matrix} ]}_{( k - 1 ) \times k ,}$$

where k is a number of classes in a classification task of said global machine learning model.

Example embodiments outlined and specified above are explained below in more specific terms.

The features of the passive party are in the hypercube [0,1] d due to the normalization of the d features.

Upon receiving the confidence scores, the adversary can construct the following system of linear equations, where X denotes the d dimensional vector of the passive party's features: AX=b, where A, b are known and X is unknown.

A_{(k-1)×d} depends on the model parameters of the passive party. In particular, A is a multiplication of a difference matrix J by the model parameters of the passive party, and the difference matrix J is defined as

$$J {=}^{Δ} {[ \begin{matrix}- 1 & 1 & 0 & 0 & … & 0 \\ 0 & - 1 & 1 & 0 & … & 0 \\ 0 & 0 & - 1 & 1 & … & 0 \\ ⋮ & ⋮ & ⋮ & ⋮ & ⋱ & ⋮ \\ 0 & … & … & 0 & - 1 & 1\end{matrix} ]}_{( k - 1 ) \times k ,}$$

where k is a number of classes in a classification task of said global machine learning model.

Further, Wₚₐₛ and b depend on i) the confidence scores, ii) the model parameters of the active party, i.e., W_{act}, and iii) the active party's features Y.

A powerful reconstruction attack is considered herein, that admits a closed-form solution. The attack is called Half*, as it is the projection of ½1, which is the (Chebyshev) center of the hypercube, onto the space of solutions to AX=b.

The estimate in this reconstruction attack is given by

$$\text{?} = {A}^{+} b + \frac{1}{2} ( J - {A}^{+} A ) 1 ,$$

where A⁺ denotes the pseudo-inverse of A.

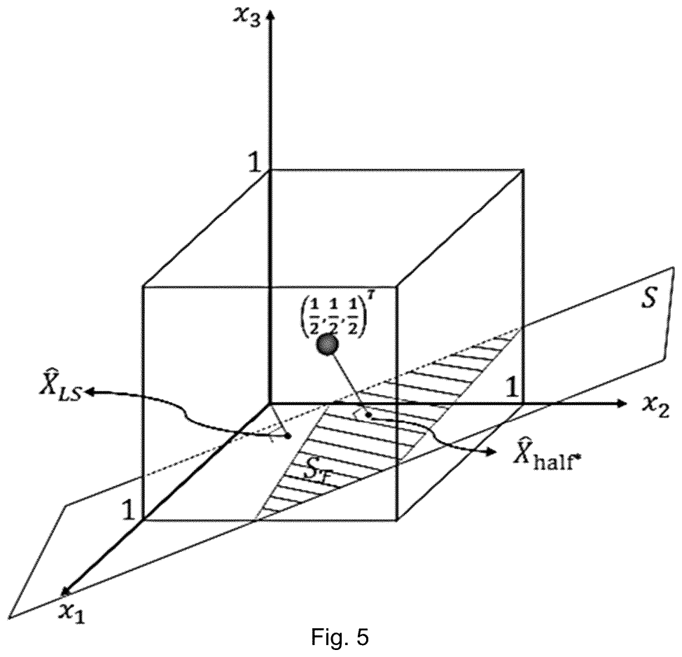

FIG. 5 shows a schematic diagram illustrating an exemplary reconstruction attack regarding a feature of a data sample, and in particular represents an illustration of the reconstruction attack Half*.

In short, in FIG. 5, [symbol] denotes all the solutions to AX=b in R^{d}, while [symbol] denotes only those solutions that are feasible, i.e., constrained in the hypercube.

Since the system has generally an infinite number of solutions, one estimate that remains almost in the center of [symbol] is the projection of the center of the cube to S. This estimate has a simple solution as in the equation above.

In FIG. 5, in addition to the illustration of the reconstruction attack Half*, a reconstruction attack [symbol] is shown, which is the projection of the origin to [symbol] . The performance of the reconstruction attack [symbol] is not as good as that of the reconstruction attack Half*. Hence, the reconstruction attack [symbol] is not considered.

While the above outlines a potential attack on the features of the data samples assigned to the passive party (i.e., available at the machine learning model implementation entity implementing the passive party but not available at the machine learning model implementation entity implementing the active party), which is a simple and powerful reconstruction attack, in the following, a defense strategy against such reconstruction attack and thus means and measures according to example embodiments are explained.

To preserve the privacy, according to example embodiments, the passive party (i.e., the machine learning model implementation entity implementing the passive party) adds some noise to its features (resulting in (X+N), where N is a random vector denoting the additive noise) before applying the features to the ML model and achieving the ML model outputs (Wₚₐₛ(X+N), where N is the random vector denoting the additive noise).

Therefore, the new confidence scores that are revealed to the adversary are c^{PPS}=σ(W_{act}Y+Wₚₐₛ(X+N)), where N is the random vector denoting the additive noise.

Ideally, the statement of the utility-privacy trade-off is to maximize the adversary's reconstruction error for a given decrease in model accuracy.

However, the model accuracy is A) generally obtained through experiments and does not admit a closed-form solution that can be used in the optimization, and is B) based on parameters that are not all available to the passive party.

Therefore, a first heuristic relaxation is to control the distance between c^{PPS} and c instead. In other words, the noise should degrade the adversary's estimate maximally while keeping the resulting confidence scores within a given neighborhood of the original ones.

However, since the passive party is unaware of the active party's model parameters and features, the passive party does not know the confidence scores. While this would not be an issue if the coordinator were in charge of protecting the privacy, relying on the coordinator would re-introduce the drawbacks (1., 2., 3.) outlined above with reference to a possible approach for facilitating privacy with respect to the passive party's features X including the coordinator adding noise to the confidence scores and revealing only a noisy version of the confidence scores to the active party.

Therefore, a second heuristic relaxation is applied, in which the passive party controls the distance between its new intermediate results, i.e., Wₚₐₛ (X+N), and the original results, i.e., WₚₐₛX. More specifically, the utility constraint would translate to bounding the expected value E[∥∥WₚₐₛN∥∥²], where the expectation is taken over the randomness of the noise. Therefore, E[∥∥WₚₐₛN∥∥²]≤α is assumed, where a is a tuning parameter for the exploration of the utility-privacy trade-off curve.

Additive noise N to be generated according to example embodiments preferably satisfies the utility constraint and degrades the adversary's reconstruction attack.

Although the passive party is generally unaware of the specific reconstruction attack employed by the adversary, for the purpose of designing the privacy-preserving scheme (PPS) to be applied according to example embodiments, application of the reconstruction attack Half* on the adversary's side is assumed, which is a potent attack and performs similarly to approximations of the minimax optimal solution.

This assumption, whether correct or incorrect in practice, allows to gain insight into how to generate N to most effectively degrade the performance of the reconstruction attack Half*.

Once a suitable way to generate N for this purpose is obtained, the PPS can be applied, regardless of the attack scheme employed by the adversary.

To maximally degrade the performance of the adversary for a given drop in utility, according to example embodiments, the passive party (i.e., the machine learning model implementation entity implementing the passive party) perturbs its features in a specific direction.

According to example embodiments, this is implemented by additive directional noise (ADN).

Namely, in the prediction phase, according to example embodiments, the passive party (i.e., the machine learning model implementation entity implementing the passive party) generates the d-dimensional noise vector N according to a multivariate Gaussian distribution [symbol] (0, S*), where

$${S}^{*} = α ( {V}_{w} {\sum }_{w}^{+} {ν}^{*} ) {( {V}_{w} {\sum }_{w}^{+} {ν}^{*} )}^{T} ,$$

where the terms in the above depend on the passive party's model parameters as follows:

$${W}_{p a s} = {U}_{w} {\sum }_{w} {V}_{w}^{T}$$

is a singular value decomposition of the passive party's model parameters, and
v* is the singular vector corresponding to the maximum singular value of

$${A}^{+} A {V}_{w} {\sum }_{w}^{+} .$$

Afterwards, according to example embodiments, the passive party (i.e., the machine learning model implementation entity implementing the passive party) reveals Wₚₐₛ (X+N) to the coordinator (or, in case no coordinator is involved, for example to the active party).

The noise is generated independent and identically distributed (i.i.d.) across predictions.

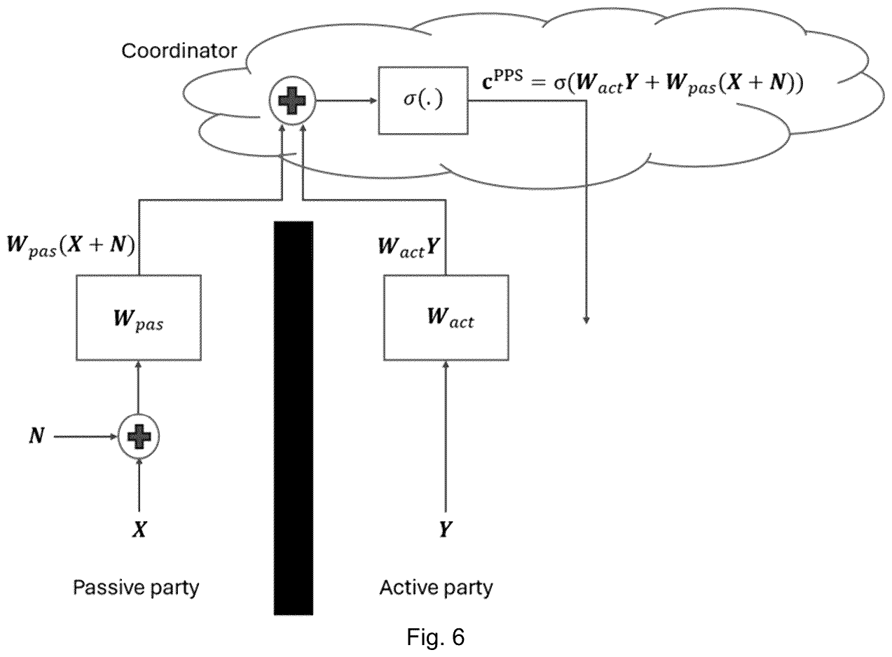

FIG. 6 shows a schematic diagram of an example of a system environment schematically illustrating a procedure according to example embodiments, and in particular illustrates generation of the d-dimensional noise vector N, application of the d-dimensional noise vector N to the passive party's features (addition of the d-dimensional noise vector N to the passive party's features), determination of the passive party's model prediction results (Wₚₐₛ (X+N)), output of these to the coordinator (while the active party determines the active party's model prediction results (W_{act}Y) and outputs these to the coordinator), and determination of the confidence scores (c^{PPS}=0 (W_{act}Y+Wₚₐₛ (X+N))) by the coordinator and feed of the confidence scores back to the active party, as explained above.

The effectiveness of the above means and measures according to example embodiments is evaluated by experiment.

Heretofore, three widely-used public datasets (Drive, Robot, and Satellite) were used for multiclass classification tasks. The datasets were obtained from the Machine Learning Repository website (D. Dua and C. Graff, “UCI machine learning repository”, 2017, http://archive.ics.uci.edu/ml).

The following table outlines the details of these datasets.

| dataset | #feature | #class | #records |
|---|---|---|---|
| Robot | 24 | 4 | 5456 |
| Satellite | 36 | 6 | 6430 |
| Drive | 48 | 11 | 58509 |

Each dataset has been divided into 80% training data and 20% test data. This was done using train test split in the sklearn package. Logistic regression (LR) was applied for the model to be trained, in training, early stopping was applied, and the training was performed with adaptive moment estimation (ADAM) optimization.

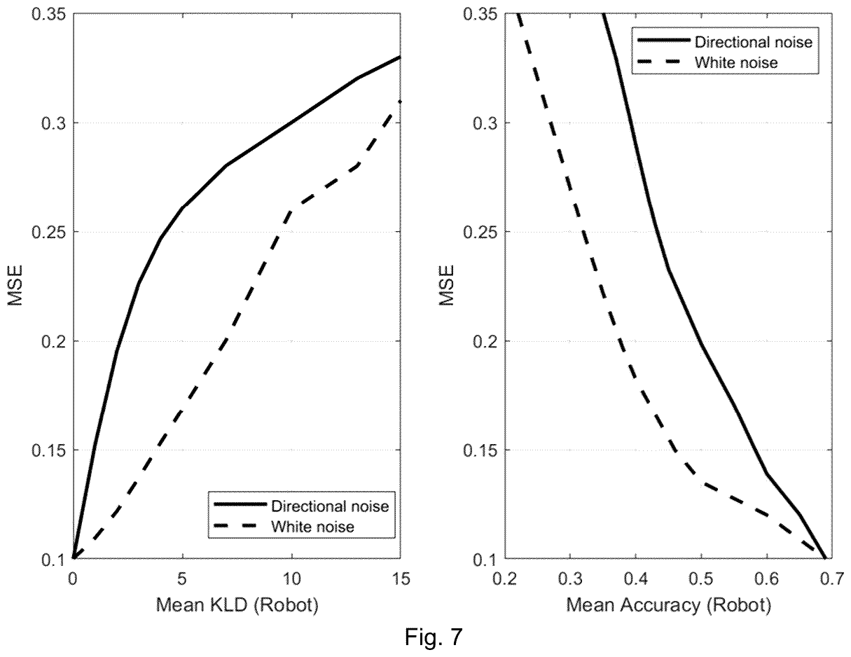

FIG. 7 shows diagrams comparing privacy preserving schemes according to example embodiments, and in particular illustrates such comparisons or the Robot dataset.

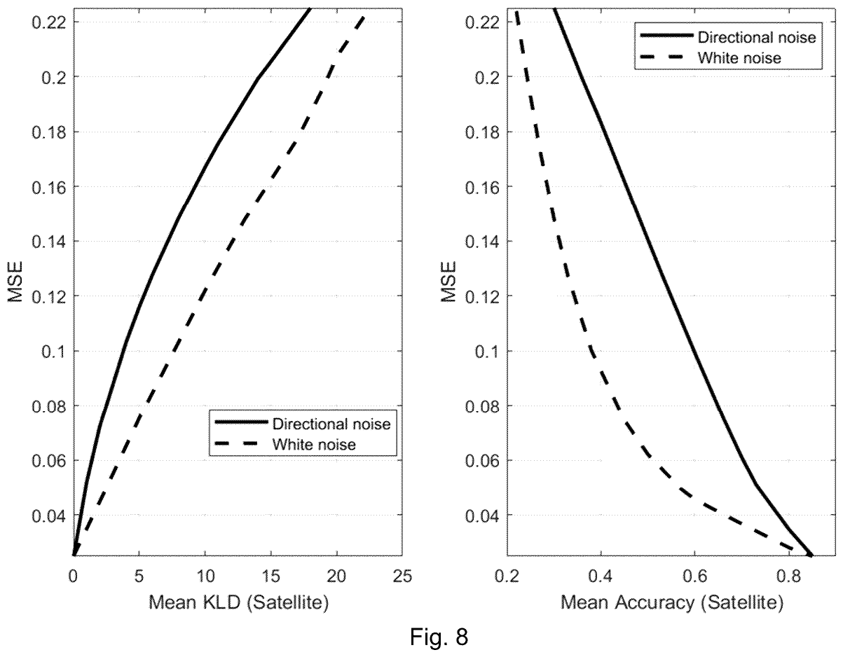

FIG. 8 shows diagrams comparing privacy preserving schemes according to example embodiments, and in particular illustrates such comparisons or the Satellite dataset.

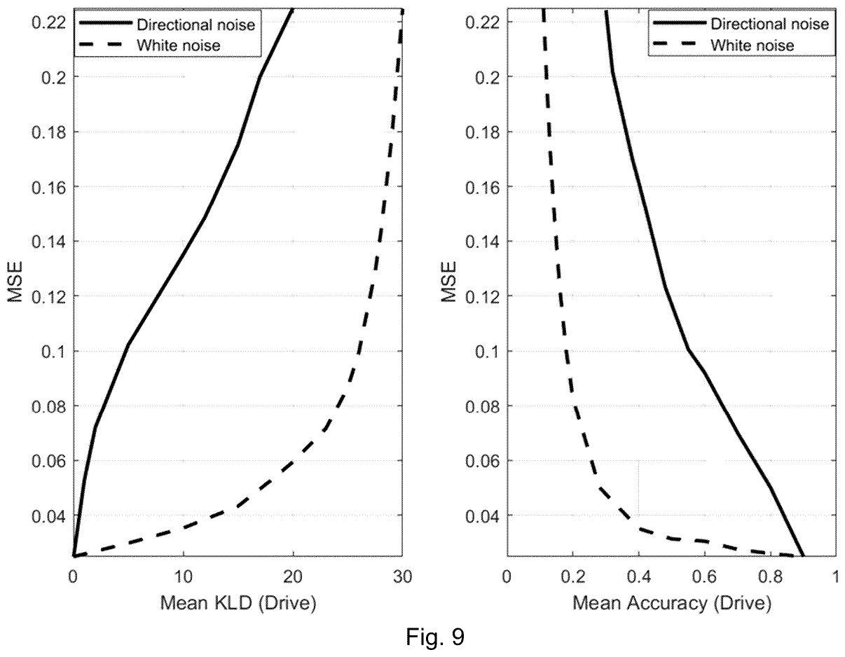

FIG. 9 shows diagrams comparing privacy preserving schemes according to example embodiments, and in particular illustrates such comparisons or the Drive dataset.

FIGS. 7 to 9 respectively illustrate the MSE per feature of the reconstruction attack Half* after the application of two privacy-preserving schemes according to example embodiments.

In these figures, the total features of the dataset under investigation are equally divided between the active and passive parties.

A solid curve represents application of directed noise by the passive party to the features on the passive party's side according to example embodiments.

A dashed curve represents application of white noise by the passive party to the features on the passive party's side according to example embodiments. In this case, the passive party adds a zero-mean white Gaussian vector [symbol] (0, αI) to its features.

The curves are plotted by tuning α.

In the respective left-hand side plot of each of FIGS. 7 to 9, the horizontal axis denotes the average Kullback-Leibler (KL) divergence between confidence scores obtained before and after the application of the privacy-preserving scheme.

In the respective right-hand side plot of each of FIGS. 7 to 9, the horizontal axis denotes the model accuracy of the VFL model.

By increasing α, both the solid and dashed curves deviate from the case without privacy protection.

However, the respective curve representing the additive directional noise application (solid curve) is superior in the sense that, for a given loss in utility, it results in more performance degradation for the adversary's reconstruction attack.

Hence, with respect to the protection of the passive party's features against reconstruction attacks in the prediction phase of a VFL, according to preferred example embodiments, the additive noise is directional as specified above.

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function.

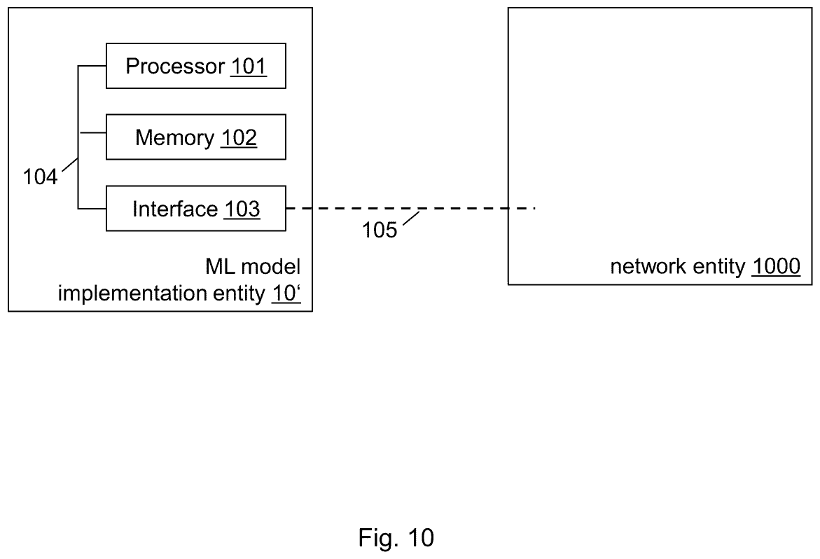

In FIG. 10, an alternative illustration of apparatuses according to example embodiments is depicted. As indicated in FIG. 10, according to example embodiments, the apparatus (machine learning model implementation entity implementing the passive party) 10′ (corresponding to the machine learning model implementation entity implementing the passive party 10) comprises a processor 101, a memory 102 and an interface 103, which are connected by a bus 104 or the like, where the apparatus may be connected via link 105 e.g. with another apparatus 1000 (an interface thereof).

The processor 101 and/or the interface 103 may also include a modem or the like to facilitate communication over a (hardwire or wireless) link, respectively. The interface 103 may include a suitable transceiver coupled to one or more antennas or communication means for (hardwire or wireless) communications with the linked or connected device(s), respectively. The interface 103 is generally configured to communicate with at least one other apparatus, i.e. the interface thereof.

The memory 102 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function.

According to example embodiments, an apparatus representing the machine learning model implementation entity implementing the passive party 10 (machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, at least one feature of said plurality of features of said data sample being assigned to said machine learning model implementation entity) comprises at least one processor 101, at least one memory 102 including computer program code, and at least one interface 103 configured for communication with at least another apparatus. The processor (i.e. the at least one processor 101, with the at least one memory 102 and the computer program code) is configured to perform calculating, for each of said at least one feature, a modified feature (thus the apparatus comprising corresponding means for calculating), and to perform determining a machine learning model prediction result for said data sample utilizing said local machine learning model and said at least one modified feature (thus the apparatus comprising corresponding means for determining).

For further details regarding the operability/functionality of the individual apparatuses, reference is made to the above description in connection with any one of FIGS. 1 to 9, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof. The present disclosure also covers a non-transitory computer readable medium comprising instructions, which, when executed by an apparatus, cause the apparatus to perform the methods herein described. The term “non-transitory”, as used herein, is a limitation of the medium itself (i.e., tangible, not a signal) as opposed to a limitation on data storage persistency (e.g., RAM vs. ROM).

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for privacy protection in vertical federated learning. Such measures exemplarily comprise, at a machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, at least one feature of said plurality of features of said data sample being assigned to said machine learning model implementation entity, calculating, for each of said at least one feature, a modified feature, and determining a machine learning model prediction result for said data sample utilizing said local machine learning model and said at least one modified feature.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

The above example embodiments include at least also the following Items:

Item 1. An apparatus of a machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, at least one feature of said plurality of features of said data sample being assigned to said machine learning model implementation entity, the apparatus comprising
at least one processor, and
at least one memory storing instructions that, when executed by the at least one processor, cause the apparatus at least to perform:
calculating, for each of said at least one feature, a modified feature, and
determining a machine learning model prediction result for said data sample utilizing said local machine learning model and said at least one modified feature.

Item 2. The apparatus according to Item 1, wherein
the instructions, when executed by the at least one processor, cause the apparatus at least to perform:
transmitting said machine learning model prediction result for said data sample.

Item 3. The apparatus according to Item 1 or 2, wherein
in relation to said calculating, the instructions, when executed by the at least one processor, cause the apparatus at least to perform:
   applying noise to said each of said at least one feature.

Item 4. The apparatus according to Item 3, wherein
in relation to said applying, the instructions, when executed by the at least one processor, cause the apparatus at least to perform:
   adding said noise to said each of said at least one feature.

Item 5. The apparatus according to Item 3 or 4, wherein said noise is directed noise.

Item 6. The apparatus according to any of Items 3 to 5, wherein
the instructions, when executed by the at least one processor, cause the apparatus at least to perform:
generating said noise based on said local model parameters.

Item 7. The apparatus according to any of Items 3 to 5, wherein
the instructions, when executed by the at least one processor, cause the apparatus at least to perform:
generating said noise based on said local model parameters and a value indicative of a target model accuracy.

Item 8. The apparatus according to Item 6 or 7, wherein
in relation to said generating, the instructions, when executed by the at least one processor, cause the apparatus at least to perform:
   obtaining a direction of said noise based on said local model parameters.

Item 9. The apparatus according to Item 8, wherein
said direction is specified in Euclidean R^{d} space.

Item 10. The apparatus according to any of Items 3 to 9, wherein
the instructions, when executed by the at least one processor, cause the apparatus at least to perform:
computing a noise vector representing said noise according to a multivariate Gaussian distribution.

Item 11. The apparatus according to Item 10, wherein
said multivariate Gaussian distribution is represented by [symbol] (0, S*),
   where

$${S}^{*} = α ( {V}_{w} {\sum }_{w}^{+} {ν}^{*} ) {( {V}_{w} {\sum }_{w}^{+} {ν}^{*} )}^{T} ,$$

where

$${\sum }_{w}^{+}$$

is a pseudoinverse of Σ_{w},

$${( {V}_{w} {\sum }_{w}^{+} {ν}^{*} )}^{T}$$

is a transpose of

$$( {V}_{w} {\sum }_{w}^{+} {ν}^{*} ) , {U}_{w} {\sum }_{w} {V}_{w}^{T}$$

is a singular value decomposition of said local model parameters,

$${V}_{w}^{T}$$

is a transpose of V_{w}, and v* is a singular vector corresponding to a maximum singular value

$${A}^{+} A {V}_{w} {\sum }_{w}^{+} ,$$

where A⁺ is a pseudoinverse of A, A is a multiplication of a difference matrix J by said local model parameters, and the difference matrix J is defined as

$$J {=}^{Δ} {[ \begin{matrix}- 1 & 1 & 0 & 0 & … & 0 \\ 0 & - 1 & 1 & 0 & … & 0 \\ 0 & 0 & - 1 & 1 & … & 0 \\ ⋮ & ⋮ & ⋮ & ⋮ & ⋱ & ⋮ \\ 0 & … & … & 0 & - 1 & 1\end{matrix} ]}_{( k - 1 ) \times k ,}$$

where k is a number of classes in a classification task of said global machine learning model.

Item 12. An apparatus of a machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, at least one feature of said plurality of features of said data sample being assigned to said machine learning model implementation entity, the apparatus comprising
calculating circuitry configured to calculate, for each of said at least one feature, a modified feature, and
determining circuitry configured to determine a machine learning model prediction result for said data sample utilizing said local machine learning model and said at least one modified feature.

Item 13. The apparatus according to Item 12, further comprising
transmitting circuitry configured to transmit said machine learning model prediction result for said data sample.

Item 14. The apparatus according to Item 12 or 13, further comprising
applying circuitry configured to apply noise to said each of said at least one feature.

Item 15. The apparatus according to Item 14, further comprising
adding circuitry configured to add said noise to said each of said at least one feature.

Item 16. The apparatus according to Item 14 or 15, wherein said noise is directed noise.

Item 17. The apparatus according to any of Items 14 to 16, further comprising
generating circuitry configured to generate said noise based on said local model parameters.

Item 18. The apparatus according to any of Items 14 to 16, further comprising
generating circuitry configured to generate said noise based on said local model parameters and a value indicative of a target model accuracy.

Item 19. The apparatus according to Item 17 or 18, further comprising
obtaining circuitry configured to obtain a direction of said noise based on said local model parameters.

Item 20. The apparatus according to Item 19, wherein
said direction is specified in Euclidean R^{d} space.

Item 21. The apparatus according to any of Items 14 to 20, further comprising
computing circuitry configured to compute a noise vector representing said noise according to a multivariate Gaussian distribution.

Item 22. The apparatus according to Item 10, wherein
said multivariate Gaussian distribution is represented by [symbol] (0, S*),
   where

$${S}^{*} = α ( {V}_{w} {\sum }_{w}^{+} {ν}^{*} ) {( {V}_{w} {\sum }_{w}^{+} {ν}^{*} )}^{T} ,$$

where

$${\sum }_{w}^{+}$$

is a pseudoinverse of Σ_{w},

$${( {V}_{w} {\sum }_{w}^{+} {ν}^{*} )}^{T}$$

is a transpose of

$$( {V}_{w} {\sum }_{w}^{+} {ν}^{*} ) , {U}_{w} {\sum }_{w} {V}_{w}^{T}$$

is a singular value decomposition of said local model parameters,

$${V}_{w}^{T}$$

is a transpose of V_{w}, and v* is a singular vector corresponding to a maximum singular value of

$${A}^{+} A {V}_{w} {\sum }_{w}^{+} ,$$

where A⁺ is a pseudoinverse of A, A is a multiplication of a difference matrix J by said local model parameters, and the difference matrix J is defined as

$$J {=}^{Δ} {[ \begin{matrix}- 1 & 1 & 0 & 0 & … & 0 \\ 0 & - 1 & 1 & 0 & … & 0 \\ 0 & 0 & - 1 & 1 & … & 0 \\ ⋮ & ⋮ & ⋮ & ⋮ & ⋱ & ⋮ \\ 0 & … & … & 0 & - 1 & 1\end{matrix} ]}_{( k - 1 ) \times k ,}$$

where k is a number of classes in a classification task of said global machine learning model.

### List of Acronyms and Abbreviations

3GPP Third Generation Partnership Project
ADAM adaptive moment estimation
AND additive directional noise
AI artificial intelligence
DAI distributed artificial intelligence
FinTech Financial Technology
FL federated learning
HFL horizontal federated learning
i.i.d. independent and identically distributed
KL Kullback-Leibler
LR logistic regression
ML machine learning
MSE mean squared error
PPS privacy-preserving scheme
VFL vertical federated learning

1. A method of a machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, at least one feature of said plurality of features of said data sample being assigned to said machine learning model implementation entity, the method comprising
calculating, for each of said at least one feature, a modified feature, and
determining a machine learning model prediction result for said data sample utilizing said local machine learning model and said at least one modified feature.

2. The method according to claim 1, further comprising
transmitting said machine learning model prediction result for said data sample.

3. The method according to claim 1, wherein
in relation to said calculating, the method further comprises
applying noise to said each of said at least one feature.

4. The method according to claim 3, wherein
in relation to said applying, the method further comprises
adding said noise to said each of said at least one feature.

5. The method according to claim 3, wherein said noise is directed noise.

6. The method according to claim 3, further comprising
generating said noise based on said local model parameters.

7. The method according to claim 3, further comprising
generating said noise based on said local model parameters and a value indicative of a target model accuracy.

8. The method according to claim 6, wherein
in relation to said generating, the method further comprises
obtaining a direction of said noise based on said local model parameters.

9. The method according to claim 8, wherein
said direction is specified in Euclidean R^{d} space.

10. The method according to claim 3, further comprising
computing a noise vector representing said noise according to a multivariate Gaussian distribution.

11. The method according to claim 10, wherein
said multivariate Gaussian distribution is represented by [symbol] (0, S*),
where
$${S}^{*} = α ( {V}_{w} {\sum }_{w}^{+} {ν}^{*} ) {( {V}_{w} {\sum }_{w}^{+} {ν}^{*} )}^{T} ,$$
where
$${\sum }_{w}^{+}$$
is a pseudoinverse of Σ_{w},
$${( {V}_{w} {\sum }_{w}^{+} {ν}^{*} )}^{T}$$
is a transpose of
$$( {V}_{w} {\sum }_{w}^{+} {ν}^{*} ) , {U}_{w} {\sum }_{w} {V}_{w}^{T}$$
is a singular value decomposition of said local model parameters,
$${V}_{w}^{T}$$
is a transpose of V_{w}, and v* is a singular vector corresponding to a maximum singular value of
$${A}^{+} {AV}_{w} {\sum }_{w}^{+} ,$$
where A⁺ is a pseudoinverse of A, A is a multiplication of a difference matrix J by said local model parameters, and the difference matrix J is defined
$$J {=}^{Δ} {[ \begin{matrix}- 1 & 1 & 0 & 0 & … & 0 \\ 0 & - 1 & 1 & 0 & … & 0 \\ 0 & 0 & - 1 & 1 & … & 0 \\ ⋮ & ⋮ & ⋮ & ⋮ & ⋱ & ⋮ \\ 0 & … & … & 0 & - 1 & 1\end{matrix} ]}_{( k - 1 ) \times k ,}$$
where k is a number of classes in a classification task of said global machine learning model.

12. An apparatus comprising
at least one processor,
at least one interface configured for communication with at least another apparatus, and
at least one memory storing instructions that, when executed by the at least one processor, cause the apparatus at least to perform
calculating, for each of at least one feature, a modified feature, wherein the apparatus being a machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, said at least one feature of said plurality of features of said data sample being assigned to said machine learning model implementation entity,
and
determining a machine learning model prediction result for said data sample utilizing said local machine learning model and said at least one modified feature.

13. The apparatus according to claim 12, wherein
in relation to said calculating, the apparatus is further caused to perform
applying noise to said each of said at least one feature.

14. The apparatus according to claim 13, wherein
in relation to said applying, the apparatus is further caused to perform
adding said noise to said each of said at least one feature.

15. The apparatus according to claim 13, wherein said noise is directed noise.

16. The apparatus according to claim 13, wherein the apparatus is further caused to perform generating said noise based on said local model parameters.

17. The apparatus according to claim 13, wherein the apparatus is further caused to perform
generating said noise based on said local model parameters and a value indicative of a target model accuracy.

18. The apparatus according to claim 16, wherein
in relation to said generating, the apparatus is further caused to perform
obtaining a direction of said noise based on said local model parameters.

19. The apparatus according to claim 18, wherein
said direction is specified in Euclidean R^{d} space.

20. A non-transitory computer readable medium comprising instructions, which, when executed by an apparatus, cause the apparatus to perform
calculating, for each of at least one feature, a modified feature, wherein the apparatus being a machine learning model implementation entity having a local machine learning model resulting from vertical federated learning of a global machine learning model, said local machine learning model being defined by local model parameters, said machine learning model implementation entity being in a prediction phase of said global machine learning model in which at least two machine learning model implementation entities including said machine learning model implementation entity determine machine learning model prediction results for a data sample, said data sample including a plurality of features disjoint among said at least two machine learning model implementation entities, said at least one feature of said plurality of features of said data sample being assigned to said machine learning model implementation entity,
and
determining a machine learning model prediction result for said data sample utilizing said local machine learning model and said at least one modified feature.
